(19) United States
(12) Patent Application Publication
(10) Pub. No.: US 2026/0007988 A1
(43) Pub. Date: Jan. 8, 2026

(54) SYSTEMS AND METHODS FOR A DRUM FILTER FOR A FRYER SYSTEM

(71) Applicant: PPM Technologies Holdings, LLC, Newberg, OR (US)

(72) Inventors: Theodore Noel Tracy, Tualatin, OR (US); Daniel Luna, Boerne, TX (US); Max William Ohlinger, Sherwood, OR (US)

(21) Appl. No.: 19/258,693

(22) Filed: Jul. 2, 2025

Related U.S. Application Data
(60) Provisional application No. 63/667,032, filed on Jul. 2, 2024.

(51) Int. Cl. B01D 33/06; A47J 37/12; B01D 33/76; B01D 33/80; B01D 35/30

(52) U.S. Cl. CPC B01D 33/06; A47J 37/1223; B01D 33/76; B01D 33/801; B01D 33/804; B01D 35/30

(57) ABSTRACT

Methods and systems are provided for a drum filter system of a fryer system. The drum filter system includes an enclosure comprised of a hood and a tank, wherein a bottom portion of the hood is reversibly coupled to a top portion of the tank, wherein the enclosure is in a closed stated when the hood is physically engaged with the tank and the enclosure is in an open state when the hood is spaced away from the tank. The drum filter system also includes an actuator coupled to the hood that when activated transitions the enclosure between the closed state and the open state.

### CROSS-REFERENCE TO RELATED APPLICATION

This application claims the benefit of U.S. Provisional Patent Application No. 63/667,032 filed Jul. 2, 2024, the entire contents of which are incorporated herein by reference.

### FIELD

The present description relates system and methods for an accessible drum filter system used to filter oil in a fryer system.

### BACKGROUND

A drum filter may be included in a fryer line to remove fine particulate food matter (e.g., fines) from fryer oil so that it may be reused without affecting a quality of the fried material. The drum filter may include a circular fines drum positioned within an enclosure. Used oil may be fed into the filter housing, as the fines drum turns, fines may be isolated on a surface of the fines drum. A fines removal conveyor may be positioned near an upper portion of the enclosure to receive the fines which are transferred from the fines drum and onto the fines removal conveyor for transportation away from the drum filter. After a duration of operation, the drum filter may demand cleaning and/or sanitization. For example, fines may become stuck in the pores of the fines drum or the fryer may demand new, pristine oil after a number of operating hours. Conventionally, cleaning may demand disassembly of the drum filter. This may include removing a side panel of the enclosure in order to access the fines drum and other internal surfaces. In some examples, a top portion of the enclosure may be removed instead of the sides, but a height and weight of the drum filter components demands use of cranes to lift the top of the enclosure and fines drum from above. Either of these systems are labor intensive and may demand additional heavy machinery such as cranes.

### SUMMARY

In one aspect, the present disclosure provides, combinable with any other aspect, an accessible drum filter system, comprising an enclosure including a hood and a tank, wherein the enclosure is in a closed state when the hood is physically engaged with the tank, a fines drum physically coupled to the hood, and an actuator coupled to the hood and configured to transition the enclosure to an open state wherein the hood is spaced away from the tank in the open state. In this way, the enclosure may be closed for operation of the accessible drum filter system and then transitioned to the opened state to allow for cleaning and/or sterilization by action of the actuator and without demanding disassembly of the drum filter enclosure.

In another aspect, the present disclosure provides, combinable with any other aspect, the accessible drum filter including a fines removal conveyor configured to be translated laterally between an operational state and a decoupled state. In the operational state, the fines removal conveyor may be positioned at least partially within the enclosure and within the fines drum. In the decoupled state, the fines removal conveyor is translated laterally away from the enclosure and is positioned outside of the enclosure. A method of operating the accessible drum filter system may include moving the fines removal conveyor to the decoupled state before transitioning the enclosure to the open state. In this way the fines drum may be free to move past the height of the fines removal conveyor and neither the fines removal conveyor, fines drum, nor the hood of the enclosure may be degraded by the transitioning of the hood.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows an example of a fryer system including a drum filter according to an embodiment of the present disclosure.

FIG. 2 shows an example of an accessible drum filter system in a closed, operational state.

FIG. 3 shows an example of the accessible drum filter system in a closed, decoupled state.

FIG. 4A shows a close up view of a fines removal conveyor of FIG. 3

FIG. 4B shows a front view of the fines removal conveyor of the accessible drum filter.

FIG. 5 shows a first view of the accessible drum filter system in an opened state.

FIG. 6 shows a second view of the accessible drum filter system in the opened state.

FIG. 7 shows a view of another embodiment of an accessible drum filter system in the opened state.

FIG. 8 shows an example of a flowchart of a method for operating the accessible drum filter system.

### DETAILED DESCRIPTION

Before any embodiments are explained in detail, it is to be understood that the embodiments described herein are provided as examples and the details of construction and the arrangement of the components described herein or illustrated in the accompanying drawings should not be considered limiting. Also, it is to be understood that the phraseology and terminology used herein is for the purpose of description and should not be regarded as limited. The use of “including,” “comprising” or “having” and variations thereof herein is meant to encompass the items listed thereafter and equivalents thereof as well as additional items. The terms “mounted,” “connected” and “coupled” are used broadly and encompass both direct and indirect mounting, connecting and coupling. Further, “connected” and “coupled” are not restricted to physical or mechanical connections or couplings, and may include electrical connections or couplings, whether direct or indirect. Also, electronic communications and notifications may be performed using any known means including direct connections, wireless connections, and the like.

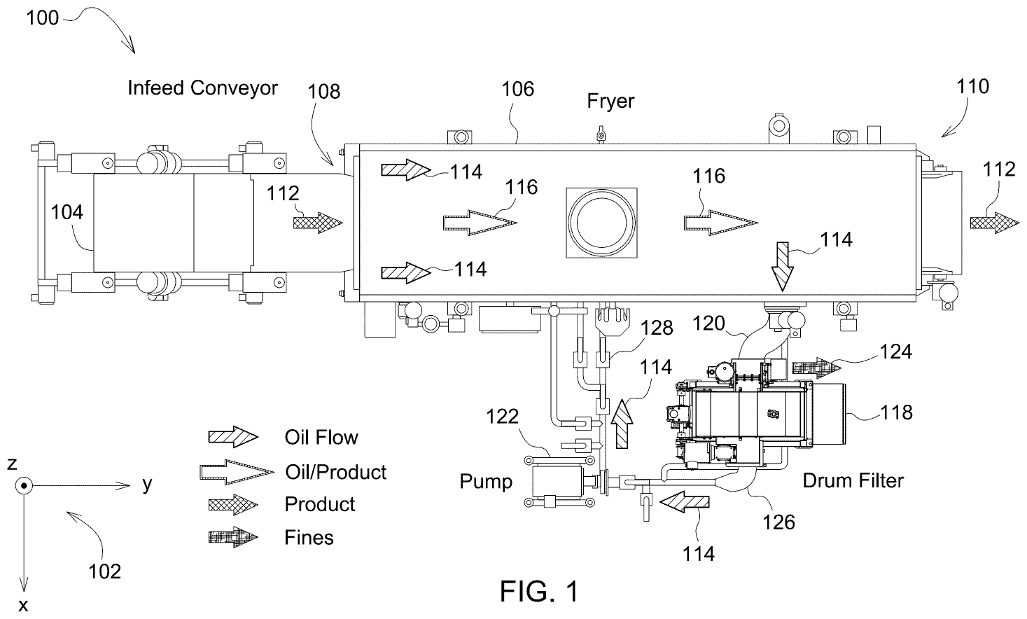

The following description relates to systems and methods for an accessible drum filter system of a fryer system. An example of the fryer system is shown in FIG. 1. As in many systems for manufacturing of food products, such as the fryer system, periodic cleaning and/or sanitization of the systems may be demanded. Conventionally, cleaning of the drum filter system may be labor intensive and time consuming because many of the food contact surfaces of the drum filter system are positioned within an enclosure. Cleaning and/or sanitization may demand opening the enclosure to access the internal surfaces. An accessible drum filter system may include an enclosure comprising a top portion and a bottom portion. The top portion of the enclosure may herein be referred to as the hood. The hood may be coupled to an actuator configured to move the hood away from the bottom portion, thereby exposing the internal surface for cleaning and/or sanitization.

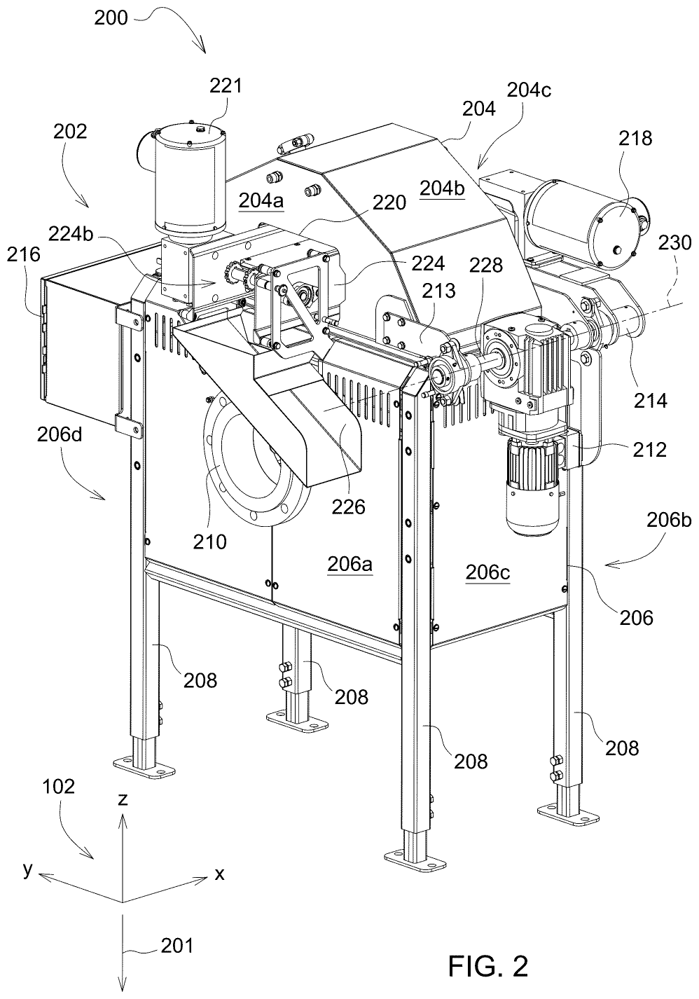

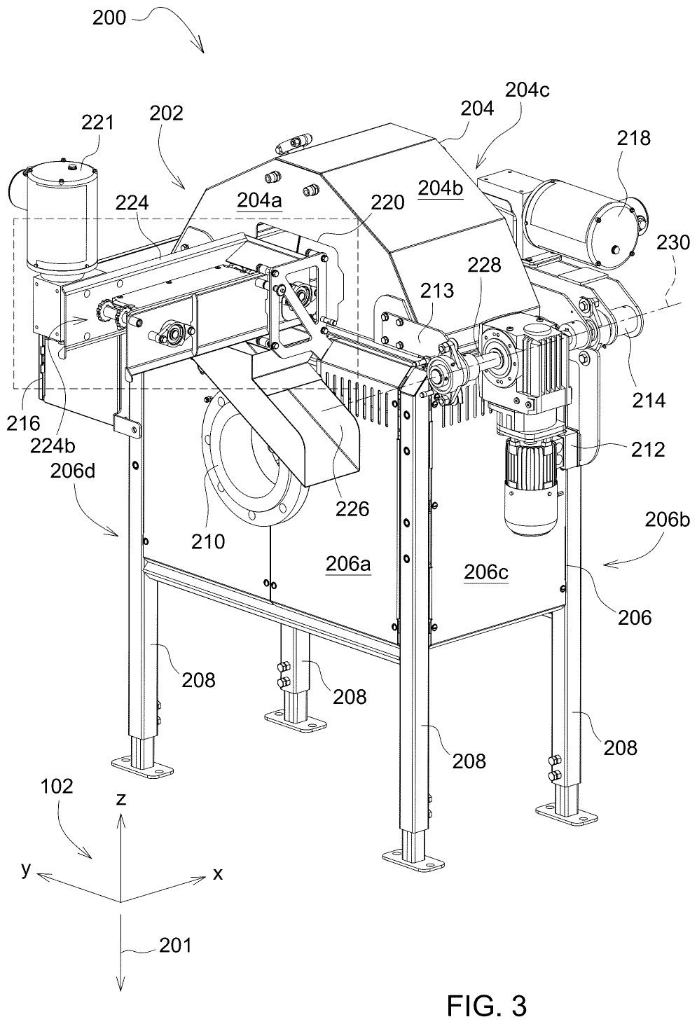

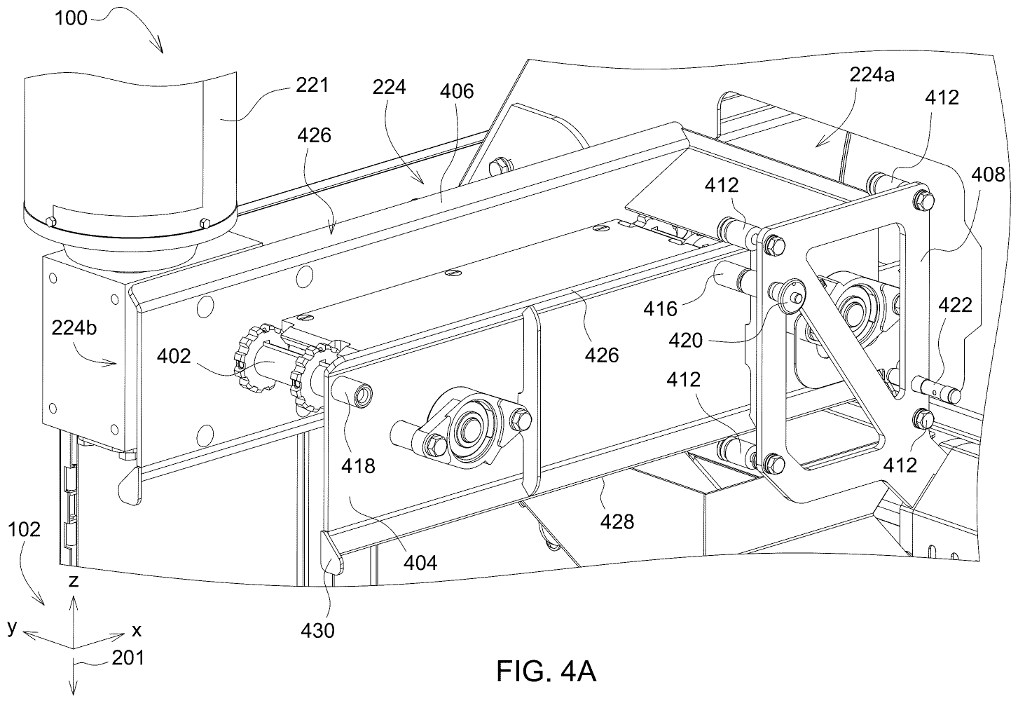

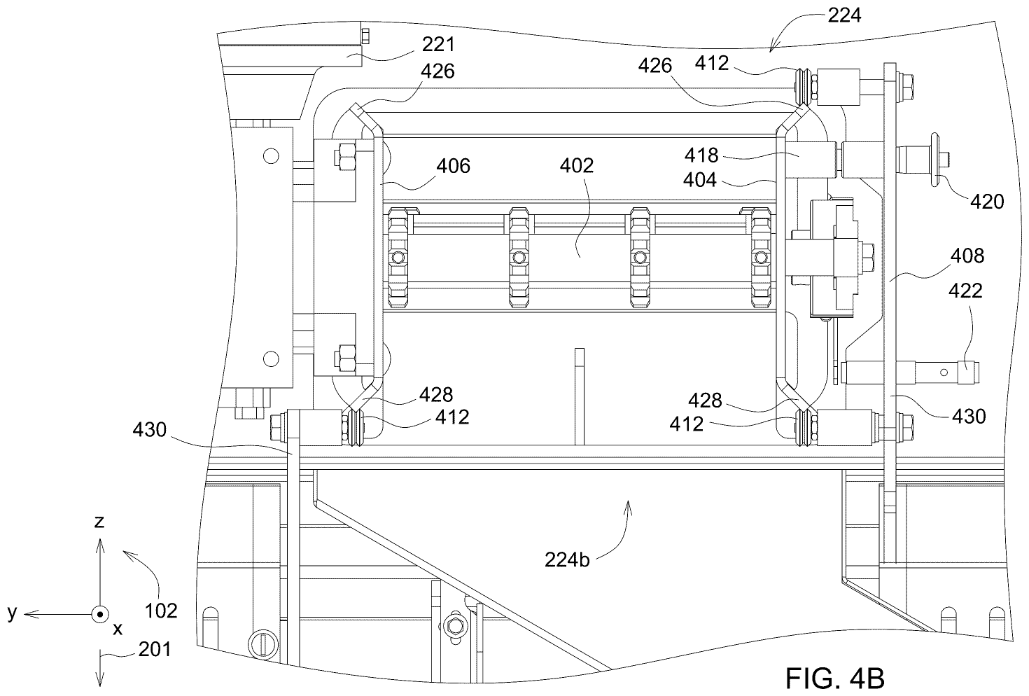

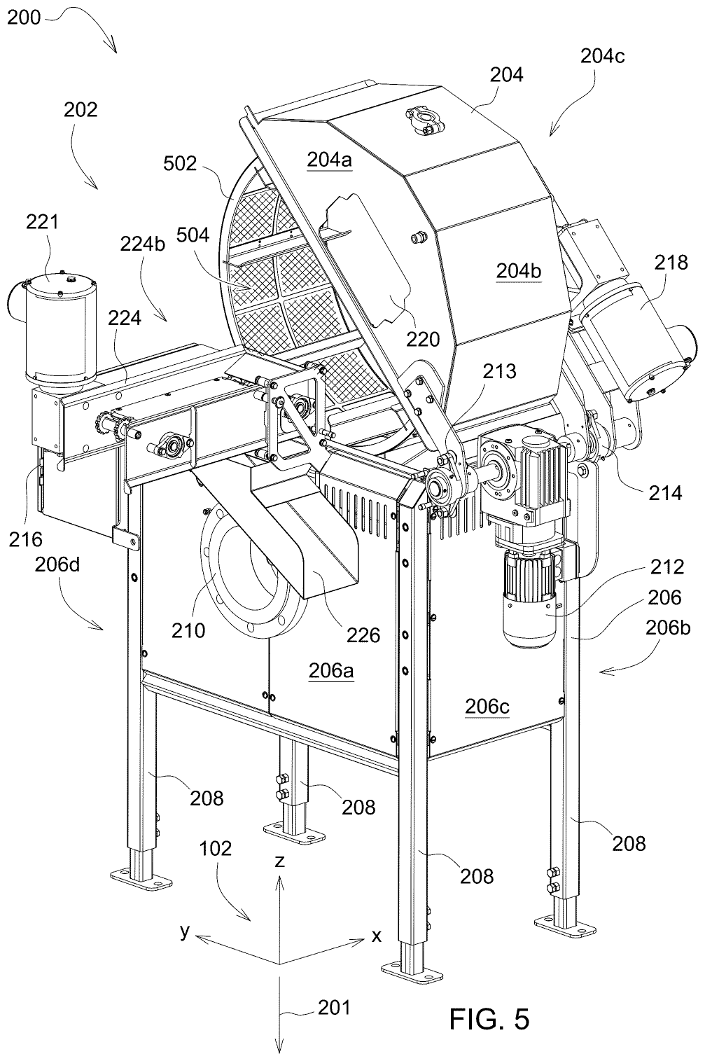

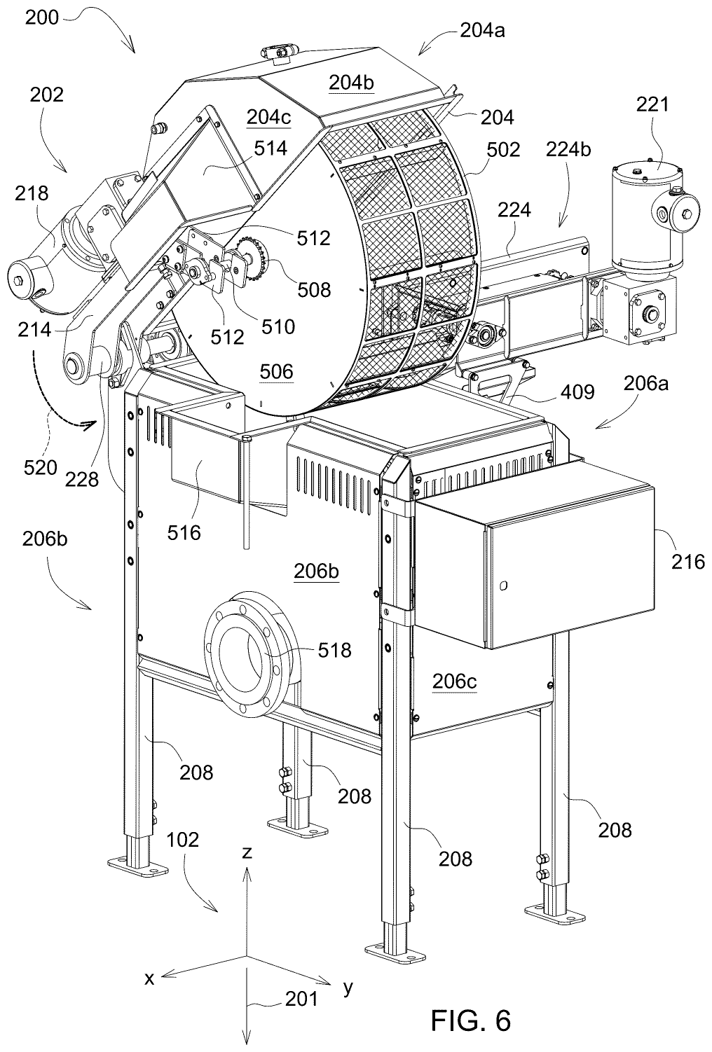

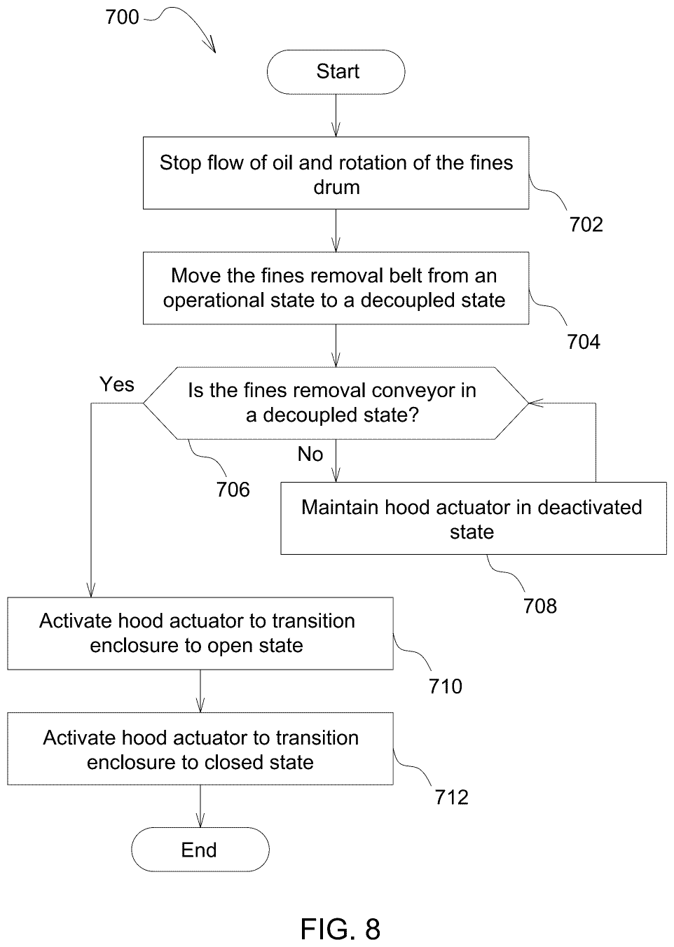

Exemplary embodiments of the accessible drum filter system is shown in FIGS. 2-7. The accessible drum filter system may be in a closed, operational state as shown in FIG. 2 when in operation as, for example, part of the fryer system. The accessible drum filter system may include a fines removal conveyor, positioned partially within the enclosure. Herein, the open and closed states refer to states of the enclosure of the accessible drum filter system and the operational and decoupled states refers to states of the fines removal conveyor. When cleaning and/or sanitization is demanded, the accessible drum filter system may first be placed in a closed decoupled state wherein the fines removal conveyor is translated laterally away from the enclosure as shown in FIG. 3. The fines removal conveyor is shown in close detail in FIGS. 4A and 4B. Cleaning and/or sanitization may commence when the accessible drum filter system is in an opened state as shown in FIGS. 5-6. The accessible drum filter system may further include a control system configured to at least partially automatically transition the accessible drum filter between the above described states. A flow chart of an example of a method for controlling the accessible drum filter system is shown in FIG. 8.

FIGS. 1-6 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above or below one another, at opposite sides to one another, or to the left or right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example. It will be appreciated that one or more components referred to as being “substantially similar and/or identical” differ from one another according to manufacturing tolerances (e.g., within 1-5% deviation).

Turning now to FIG. 1, it shows a non-limiting exemplary embodiment of a fryer system 100. An axes system 102 is provided for a comparison between the views of FIGS. 1-6. Axes system 102 includes a z-axis, x-axis, and y-axis. The y-axis may correspond to a longitudinal axis and the x-axis may correspond to a lateral axis. The z-axis may be perpendicular to the x and y axes and may correspond to a vertical axis. Additionally, the x-axis may be parallel to a rotational axis of a fines drum of the drum filter system.

Fryer system 100 may include an infeed conveyor 104 physically coupled to a fryer 106. Product being fried (e.g., potato slices) may be moved longitudinally into a product inlet end 108 of fryer 106. Fryer 106 may include heated reservoirs of oil and moving the product longitudinally through fryer 106 may fry the product in the oil. The fried product may be collected from a product outlet end 110 of fryer 106 and moved to a next stage of processing. Arrows 112 indicate a direction of product moving through fryer system 100, arrows 114 indicate a direction of oil moving through fryer system 100, and arrows 116 indicate a direction of oil and product moving together through fryer system 100, according to the non-limiting exemplary embodiment. Other flow configurations are also considered, such as oil and product moving in opposite directions.

As indicated by arrows 112 and 114, oil may flow longitudinally from product inlet end 108 and contact the product within fryer 106 to commence cooking. The oil and product may flow together through fryer 106 for a desired cooking time. Before reaching the outlet end 110 of fryer 106 oil may be diverted laterally towards a drum filter system 118 while product is directed longitudinally out of the outlet end 110 of the fryer 106. Drum filter system 118 may be fluidly coupled to fryer 106 via a drum filter inlet pipe 120. Oil may be pulled through drum filter system 118 by a pump 122 fluidly coupled to the drum filter system 118 and fryer 106. Oil may be pulled from inside a fines drum of the drum filter system 118 to outside the fines drum, leaving fine product particulates (e.g., fines) on an inner surface of the fines drum and clean oil external to the fines drum. Fines may be directed away from drum filter system 118 via a fines chute as indicated by the arrow 124. Clean oil, free of fines, may be directed by pump 122 through a drum filter outlet pipe 126 and back into fryer 106 via a fryer oil inlet pipe 128. In this way, oil may be cycled through fryer system 100 with fines removed on each cycle to prevent product degradation of the oil and off-flavors which may occur if fines are not removed.

Occasionally, a drum filter system, such as drum filter system 118, may demand cleaning or sanitization. Because the oil and fines contact an interior surface of the drum filter, cleaning may demand opening an enclosure of the drum filter to expose the inner surfaces. Other methods for cleaning the drum filter system may demand disassembling a portion of the drum enclosure, and in some examples, heavy equipment to move a fines drum and hood of the enclosure out of the way. An accessible drum filter system is configured to hinge a hood and fines drum away from a bottom portion of the enclosure, thereby exposing the inner surface of the accessible drum system for cleaning or sanitization. Additionally, the accessible drum filter system includes a sliding mechanism to account for moving a fines conveyor away from the enclosure, thereby preventing the fines conveyor and supporting features of the fines conveyor, such as V-groove wheels, from degrading due to the cantilevering or otherwise raising of the hood and fines drum.

An exemplary embodiment of an accessible drum filter system 200 in a closed, operational position is shown in FIG. 2. Herein, a state of accessible drum filter system 200 may be determined by a state of an enclosure 202 and a fines removal conveyor 224. The enclosure may be in an open state or a closed state. The fines removal conveyor 224 may be in an operational state or a decoupled state. Accessible drum filter system 200 may be an example of drum filter system 118 shown in FIG. 1. In a closed, operational state, accessible drum filter system 200 may be ready to receive used oil from a fryer, filter the oil through the drum filter, output removed fines and recycle the filtered oil back to the fryer.

Accessible drum filter system 200 may include an enclosure 202. Enclosure 202 may include a hood 204 and a tank 206. An exterior portion of tank 206 shown in FIG. 2 may be referred to as a tank guard or tank frame. The oil containing portion of tank 206 may not be visible in FIG. 2 and may be positioned within the tank guard. The tank guard may be configured to shield the heat of the tank from users. Hood 204 may comprise a top of enclosure 202 while tank 206 comprises a bottom of enclosure 202, with respect to gravity. A direction of gravity corresponds to a negative vertical direction and is shown by an arrow 201. Hood 204 and tank 206 may be formed as physically separate components. Further, a bottom portion hood 204 may be reversibly engaged with a top portion of tank 206. Herein, reversibly engaged components may be repeatedly physically coupled and decoupled without degradation of either component. In some examples bottom edge of hood 204 may engage with the top edge of tank 206 to form a seal. Additionally or alternatively, hood 204 may nest slightly within tank 206 as shown in FIG. 2 to form the seal. In some examples, an oil level inside tank 206 is below the interface of tank 206 and hood 204 and an airtight and/or water/oil tight seal may not be demanded.

The tank guard portion of tank 206 visible in FIG. 2 may be roughly shaped as rectangular prism including a first lateral side 206a, a second lateral side 206b, a first longitudinal side 206c, and a second longitudinal side 206d. Tank 206 may also include an oil containing portion, not visible in FIG. 2, positioned within the tank frame. In some examples, the oil containing portion may be shaped as a triangular prism. In alternate examples, the tank guard portion may be omitted. Other shapes and dimensions of the tank guard and oil containing portion are also considered within the scope of the disclosure. First lateral side 206a may include an oil inlet 210. Oil inlet 210 may receive used oil from a fryer (e.g., fryer 106 of FIG. 1). A plurality of legs 208 may extend downward from tank 206 and may be configured to support tank 206 a height off the ground. In some examples accessible drum filter system 200 may include four legs. In further examples, the plurality of legs 208 may be formed continuously with tank 206.

Hood 204 may be roughly dome shaped, conforming to a curve of a drum filter of the accessible drum filter system. Hood 204 may include a first lateral side 204a, an arched top side 204b, and a second lateral side 204c. First lateral side 204a may include a fines removal conveyor opening 220. Fines removal conveyor opening 220 may circumferentially surround a portion of a fines removal conveyor 224 when accessible drum filter system 200 is in the closed, operational state. In the closed, operational state, a first end of fines removal conveyor 224 may be positioned within enclosure 202 and a second end 224b may be positioned outside of enclosure 202. In this way, fines removal conveyor 224 may be configured to receive fines collected from an internal surface of the fines drum and convey the fines to outside enclosure 202.

As shown in FIG. 2, fines removal conveyor 224 may be a fines removal belt 224. Herein, a conveyor is a device configured to move matter between two points. The conveyor may be an active conveyor where kinetic energy such as vibration or rotation is input to move the matter. The conveyor may also be a passive conveyor where the energy to move the matter is not input by the conveyor, such as a funnel or chute. In some examples, fines removal conveyor 224 may be a passive or active conveyor as described above and configured to move fines from inside enclosure 202 to outside of enclosure 202. In some examples, fines removal conveyor 224 may not be a belt and may instead be an auger, vibratory conveyor, chain conveyor, gravity funnel, among others. A belt motor 221 may be mechanically coupled to fines removal conveyor 224 and configured to move rollers of fines removal conveyor 224 to transport fines laterally away from accessible drum filter system 200. A chute 226 may be positioned to receive fines from second end 224b of fines removal conveyor 224. As one example, chute 226 may be physically coupled to tank 206. As a further example, chute 226 may be physically coupled to the tank frame of tank 206. In some examples, chute 226 may be coupled to an upper portion of the tank frame. In alternate examples, chute 226 may be coupled to a lower portion of tank 206 or underneath tank 206. Chute 226 may receive the fines and deliver the fines to a bin or other method of containing the fines.

A first bracket 213 may be coupled to first lateral side 204a of hood 204 and a second bracket 214 may be coupled to second lateral side 204c of hood 204. As one example, the first bracket 213 and second bracket 214 may be positioned close to the interface of hood 204 and tank 206. First bracket 213 and second bracket 214 may each extend longitudinally past first longitudinal side 206c of tank 206. A rotational arm 228 may extend between first bracket 213 and second bracket 214. First bracket 213 and second bracket 214 may each be fixedly coupled to opposite ends of rotational arm 228.

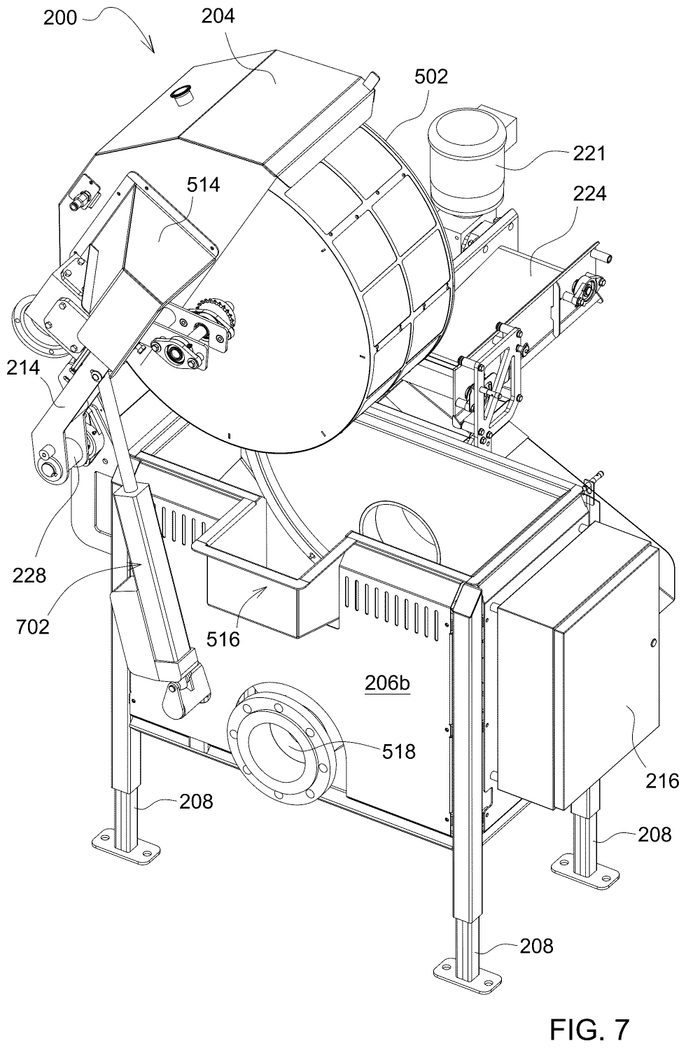

A hood motor 212 may circumferentially surround rotational arm 228. Hood motor 212 may be rotationally coupled to rotational arm 228 and may be configured to rotate rotational arm 228 around a rotational axis 230. Rotational axis 230 may be perpendicular to the rotational axis of the fines drum. Further, rotational axis 230 may be parallel to a direction of oil travel through accessible drum filter system 200. Hood motor 212 may be an example of an actuator, more specifically a hood actuator, physically coupled to the hood and configured to move enclosure 202 between the open state and the closed state. For example, the actuator may move the hood vertically upwards and downwards to couple and decouple the hood from the tank. Another example of a hood actuator is shown in FIG. 7, whereby a linear actuator 702 is used to move the hood 204 relative to the tank 202 such that the enclosure 202 is in an opened state.

A drum drive motor 218 may be physically coupled to a fines drum of the accessible drum filter system 200, the fines drum positioned internal to enclosure 202 when accessible drum filter system 200 is in closed operational mode. Drum drive motor 218 may be coupled to the fines drum via a reducer and chain drive system. The fines drum is described further below with respect to FIGS. 5-6. Drum drive motor 218 may be configured to rotate the fines drum about a rotational axis of the fines drum which is parallel to the x-axis.

Accessible drum filter system 200 may include a controller 216. Controller 216 may be communicatively coupled to sensors, actuators, and motors of accessible drum filter system 200. Controller 216 may include a non-volatile memory configured to store instructions for operation of accessible drum filter system 200. As one example, controller 216 may be a programmable logic controller. In some examples, controller 216 may also include a user interface. In further examples, the user interface may include a user input for control of actuators of accessible drum filter system 200 by an operator, such as activating and deactivating hood motor 212. In alternate examples, hood motor 212 and other actuators/motors of accessible drum filter system may be manually activated and deactivated by user controls of the respective actuators and motors.

When a cleaning or sterilization of accessible drum filter system 200 is desired, an operator may first transition accessible drum filter system 200 to a closed decoupled state. An operator may first stop a flow of oil through the accessible drum filter system 200 and stop rotation of the fines drum before transitioning to the closed decoupled state. In further examples, the fines drum may continue rotating after transitioning to the closed decoupled state. An example of accessible drum filter system 200 in the closed decoupled state is shown in FIG. 3. FIG. 3 may include the same components as discussed above with respect FIG. 2. The components are labeled the same and are not reintroduced.

In the closed decoupled state, fines removal conveyor 224 may be moved laterally away from an interior of enclosure 202 until both first end 224a and second end 224b are positioned outside of hood 204. Belt motor 221 may be fixedly coupled to fines removal conveyor 224 and may move laterally along with fines removal conveyor 224. Chute 226 may be fixedly coupled to first lateral side 206a of tank 206 and may not move when fines removal conveyor 224 is moved from the operational state (FIG. 2) to the decoupled state (FIG. 3).

Fines removal conveyor 224 and a mechanism of translation of fines removal conveyor 224 is now described further with respect to FIG. 4A, showing a portion of fines removal conveyor 224 and FIG. 4B showing a view of fines removal conveyor 224 viewed from second end 224b.

Fines removal conveyor 224 may include rollers 402 mechanically coupled to belt motor 221 and configured to rotate and transport fines recovered from the fines drum from first end 224a to second end 224b. Rollers 402 may be supported at both axial ends by frames including a first frame 404 and second frame 406. As one example, belt motor 221 may be physically coupled to second frame 406. First frame 404 and second frame 406 may each extend laterally past positions of rollers 402. Top and bottom (e.g., with respect to gravity) edges of first frame 404 and second frame 406 may each be bent away from rollers 402, forming top rails 426 and bottom rails 428.

Fines removal conveyor 224 may be coupled to tank 206 by a full support 408 and a half support 409. Half support 409 is obscured by fines removal conveyor 224 in FIGS. 4A-4B and is shown in FIG. 6. Both full support 408 and half support 409 may be physically coupled to tank 206. Full support 408 may be coupled to first frame 404 and half support 409 may be coupled to second frame 406. As one example, full support 408 may be shaped roughly as a rectangle or square. Full support 408 may extend vertically above and below first frame 404. Wheels 412 may be positioned at top and bottom portions of full support 408 and may extend longitudinally from full support 408 to first frame 404. Wheels 412 may couple to top rail 426 and bottom rail 428 of first frame 404. In some examples wheels 412 of full support 408 may include four wheels, two coupled to top rail 426 and two coupled to bottom rail 428. Additionally, half support 409 may include wheels 412, extending from a top edge of half support 409. Wheels 412 of half support 409 may couple to bottom rail 428 of second frame 406. As one example, half support 409 may include two wheels. Half support 409 may not extend vertically past bottom rail 428 of second frame 406. The portion of wheels 412 in contact with top rail 426 and bottom rail 428 of first frame 404 and second frame 406 may rotate to facilitate lateral movement of fines removal conveyor 224 from being in an operational state, positioned partially inside hood 204 to being in the decoupled state, positioned outside of hood 204. Additionally, wheels 412, full support 408, and half support 409 may be configured to support fines removal conveyor 224 in both the operational and decoupled states. For example, dimensions of full support 408 and half support 409 as well as a size and spacing of wheels may be selected to hold fines removal conveyor 224 horizontally while supporting fines removal conveyor 224 from either the first end 224a or second end 224b. Further, bottom rails 428 may include perpendicular portions 430, positioned at first end 224a and second end 224b of fines removal conveyor 224. Perpendicular portion 430 may extend longitudinally from bottom rails 428 and may prevent fines removal conveyor 224 from rolling off wheels 412.

A locking mechanism 420 may additionally be coupled to full support 408. When fines removal conveyor 224 is in the operational state, locking mechanism 420 may be aligned vertically and laterally with an operational fixing member 418. Operational fixing member 418 may be physically coupled to first frame 404 and positioned between the top rail and the bottom rail towards second end 224b of fines removal conveyor 224. Locking mechanism 420 may engage with operational fixing member 418 to prevent fines removal conveyor 224 from moving in the lateral direction. In one example, an operator may manually adjust locking mechanism 420 to engage and disengage locking mechanism 420 from operational fixing member 418. In alternate examples, locking mechanism 420 may be automatically or semi-automatically engaged and disengaged from operational fixing member 418 by a command from controller 216. Similarly, when fines removal conveyor 224 is in the decoupled state, locking mechanism 420 may be vertically and laterally aligned with decoupled fixing member 416. Decoupled fixing member 416 may be positioned vertically and laterally to align with locking mechanism 420 when fines removal conveyor 224 is in the decoupled position. As one example, locking mechanism 420 may be a dowel configured to slide in the longitudinal direction and operational fixing member 418 and decoupled fixing member 416 may be configured as openings sized to receive the dowel. Other locking mechanisms (e.g., magnetic/electromagnetic, friction based, and the like) are also considered.

Additionally, a sensor 422 may be coupled to full support 408. Sensor 422 may be configured to detect if fines removal conveyor 224 is in the operational state or decoupled state. Sensor 422 may be an optical sensor, electrical sensor, magnetic sensor, or the like. Sensor 422 may be communicatively coupled to controller 216. Sensor 422 may send a signal to controller 216 indicating if fines removal conveyor 224 is in the operational or decoupled state.

Turning now to FIGS. 5-6, accessible drum filter system 200 is shown in an open state. FIG. 5 shows the accessible drum filter system 200 from a first perspective and FIG. 6 shows accessible drum filter system 200 from a second perspective, opposite the first perspective along the x-axis. The second perspective shows the second lateral side of tank 206 and the second lateral side of hood 204. The two perspectives are described together.

FIGS. 5-6 illustrates fines drum 502. Fines drum 502 may be shaped as a cylinder and may be positioned at least partially within enclosure 202. A curved surface of the cylinder may be formed of a mesh. Fines drum 502 may include an open face 504 and a closed face 506. Open face 504 may be closest to first lateral side 206a of tank 206. The open face may be configured to receive a mixture of oil and fines. Closed face 506 of fines drum 502 may be closest to second lateral side 206b of tank 206. Oil may be pulled through the mesh curved surface of fines drum 502 and exit tank 206 via oil discharge opening 518. Oil discharge opening 518 may fluidly couple to a pump, such as pump 122 of FIG. 1, configured to pull oil through fines drum 502. A rotational gear 508 may be positioned at a center of closed face 506. Rotational gear 508 may mechanically couple fines drum 502 to drum drive motor 218. In this way fines drum 502 may be rotated within enclosure 202 by drum drive motor 218 when accessible drum filter system 200 is in the closed operational position. A shaft 510 may couple drum 502 to rotational gear 508. Shaft 510 may pass through bearings of brackets 512. Brackets 512 may be physically coupled to second bracket 214, which may in turn be coupled to hood 204. Hood 204 may include a protrusion 514 configured to cover shaft 510 and brackets 512 when in a closed state. Tank 206 may include a matching protrusion 516, also configured to accommodate shaft 510 and brackets 512 in the closed state. Further, protrusion 514 of hood 204 may mate with protrusion 516 of tank 206 when in the closed state. In this way, moving hood 204 upward and into the open state also pulls fines drum 502 upward as brackets 512 and shaft 510 mechanically couple drum 502 to hood 204. In a closed position fines drum 502 may rest on a guide positioned on an interior surface of tank 206. In some examples the guide may act as a seal.

In the open state, fines removal conveyor 224 may be in the decoupled position and hood 204 may be spaced away from tank 206. Because fines drum 502 is physically coupled to hood 204, moving hood 204 upwards also moves fines drum 502. In the open position, hood 204 may be spaced away from tank 206 by a distance to also position fines drum 502 outside of tank 206. In an exemplary embodiment, hood 204 and fines drum 502 may be cantilevered in an open state by rotation of rotational arm 228 by hood motor 212. Rotational arm 228 may be rotated counter clockwise as viewed in FIG. 6 and indicated by arrow 520. Rotation of rotational arm 228 may move first bracket 213 and second bracket 214 from being roughly parallel with a top edge of tank 206 to being angled upward. Because first bracket 213 and second bracket 214 are coupled to hood 204, angling first bracket 213 and second bracket 214 upwards concertedly causes hood 204 and fines drum 502 to be cantilevered above tank 206.

Other mechanisms and methods of lifting hood 204 and fines drum 502 are also considered. For example, in place of rotational arm 228, actuators moving vertically may be configured to lift hood 204 and thereby fines drum 502 completely vertically away from tank 206. Additionally or alternatively, fines removal conveyor 224 may be physically coupled to hood 204 instead of tank 206. In examples where fines removal conveyor 224 is physically coupled to hood 204, fines removal conveyor 224 may move concertedly with hood 204 when the enclosure transitions between the open and closed states. Further, in such examples, fines removal conveyor 224 may not translate laterally between a coupled and decoupled configuration as when moving in concert with hood 204 and fines drum 502, neither may be degraded.

FIG. 7 illustrates another example of a hood actuator for use in the drum filter system 202 for lifting the hood 204 of the enclosure 202 relative to the tank 206. Like reference numerals from FIGS. 5-6 will be used in FIG. 7 to describe similar features. The hood actuator is a linear actuator 702 coupled between the tank 206 and the bracket 214 of the hood 204. As the linear actuator 702 extends, the hood 204 and fines drum 202 are moved relative to the tank 206 and the hood rotates about the rotational arm 228 and rotational axis 230 to move the enclosure to the open state. As the linear actuator 702 is retracted, the hood 204 rotates back towards the tank 206 to move the enclosure to the closed state. Although a single actuator 702 is shown in FIG. 7, in other examples, the hood actuator may include a pair of linear actuators, one located on each side of the enclosure 202. Further, in other examples, the hood actuator or linear actuator(s) 702 may lift the hood 204 vertically with respect to the tank 206 rather than having an axis of rotation 230.

In the open decoupled state, a lowest edge of fines drum 502 may be even with or above a lowest edge of fines removal conveyor 224. Because the fines removal conveyor 224 is laterally translated outside of hood 204, fines drum 502 may be lifted in the open state without contacting fines removal conveyor 224. In the operational state, fines removal conveyor 224 may be positioned at least partially inside hood 204 and fines drum 502 and lifting to the open state may not be possible due to physical contact between fines removal conveyor 224 and an interior surface of fines drum 502. In the open decoupled state, interior surfaces of enclosure 202 and fines drum 502 may be exposed and accessible drum filter system 200 may be cleaned and/or sterilized. For example, an operator may access each interior surface of the oil containing portion of tank 206 and fines drum 502.

Turning now to FIG. 8, it shows a flowchart of an example of a method 700 for actuating an accessible drum filter system, such as accessible drum filter system 200 described above. One or more steps of method 700 may be stored as instructions in non-volatile memory of a controller such as controller 216.

At 702, method 700 includes stopping flow of oil to the accessible drum filter system 200 and stopping rotation of the fines drum 502. In some examples stopping flow of oil may also include pulling as much oil as possible out of the accessible drum filter system via action of a pump, such as pump 122.

At 704, method 700 includes moving the fines removal conveyor 224 from an operational state to a decoupled state. In the operational state, the fines removal conveyor 224 may be positioned at least partially within an enclosure of the accessible drum filter system 200. In the decoupled state, the fines removal conveyor 224 may be positioned outside of the enclosure 202. Additionally, moving the fines removal conveyor 224 may further include first disengaging a locking mechanism 420 holding the fines removal conveyor 224 in the operational state, moving the fines removal conveyor 224, and then re-engaging the locking mechanism 420 when the fines removal conveyor 224 is in the decoupled state. Moving the fines removal conveyor 224 may include laterally translating the fines removal conveyor 224 by rails 426, 428 supported by wheels 412. In some examples, moving the fines removal conveyor 224 may be done manually by an operator of the accessible drum filter system 200. For example, the operator may grasp the fines removal conveyor 224 and pull the fines removal conveyor 224 away from the enclosure 202. In alternate examples, the fines removal conveyor 224 may be moved automatically. For example, the wheels 412 and locking mechanism 420 may be motorized and the controller 216 may actuate the locking mechanism 420 and wheels 412 in response to a command to stop rotation of the fines drum 502 and flow of oil.

At 706, method 700 determines if the fines removal conveyor 224 is in the decoupled state. Determining if the fines removal conveyor 224 is in the decoupled state may include measuring a signal from a sensor 422 of the fines removal conveyor 224. The sensor 422 may send a signal to the controller 216 to indicate if the fines removal conveyor 224 is in the decoupled state. If the fines removal conveyor 224 is not in the decoupled state (NO), method 700 proceeds to 708 and includes maintaining a hood actuator in a deactivated state. The hood actuator, such as hood motor 212, may be configured to move the hood 204 vertically upward to transition the enclosure 202 from a closed state to an open state. Transitioning the enclosure 202 to an open state when the fines removal conveyor 224 is in the operational state may physically degrade the hood, fines drum, and fines removal conveyor.

If at 706, method 700 determines that the fines removal conveyor 224 is in the decoupled state (YES), method 700 proceeds to 710 and includes activating the hood actuator to transition the enclosure 202 to the open state. Transitioning the enclosure 202 to the open state may include moving the hood 204 vertically upward to decouple the hood 204 from the tank 206 and concertedly moving the fines drum 502, physically coupled to the hood 204. In the open state, the hood 204 may be positioned above the tank 206 of the enclosure 202. Further, the fines drum 502 may be physically coupled to the hood 204 and may therefore also be positioned vertically above the tank 206. In this way, an interior surface of the accessible drum filter system 200 may be accessed for cleaning and/or sterilization. In some examples, the hood 204 and fines drum 502 may be cantilevered above the tank 206. Cantilevering the hood 204 above the tank 206 may be more space efficient than raising the hood 204 vertically straight up (e.g., not cantilevered at an angle), whereas lifting the hood 204 straight up may be more efficient as the drum diameter increases. After cleaning/sterilization or any other actions that demand the enclosure 202 in the open state, method 700 proceeds to 712 and includes activating the hood actuator to transition the enclosure 202 to the closed state. Transitioning the enclosure 202 to the closed state may include vertically moving the hood 204 downwards and concertedly moving the fines drum 502 until the hood 204 is physically coupled to the tank 206 and the fines drum 502 rests inside the tank 206. Method 700 ends.

The technical effect of method 700 and the systems described herein is a fines drum system that is accessible for cleaning and/or sanitization without demand for disassembly. The system may incorporate a movable fines removal conveyor. Moving the fines removal conveyor outside of the hood provides clearance for both the hood and fines drum to be lifted and/or cantilevered upwards. The method and sensors may prevent accidental degradation by contacting the fines removal conveyor with the fines drum during actuation. An amount of downtime and resources for cleaning and/or sanitizing the accessible drum filter system may be reduced compared to a conventional drum filter system.

The disclosure also provides support for a drum filter system of a fryer system, comprising, an enclosure comprising a hood and a tank, wherein a bottom portion of the hood is reversibly coupled to a top portion of the tank, wherein the enclosure is in a closed state when the hood is physically engaged with the tank and the enclosure is in an open state when the hood is spaced away from the tank, a fines drum physically coupled to the hood, and positioned at least partially within the enclosure, an actuator coupled to the hood that when activated transitions the enclosure between the closed state and the open state. In a first example of the system, the fines drum is spaced away from the tank in the open state. In a second example of the system, optionally including the first example, the actuator moves the hood vertically upward and away from the tank. In a third example of the system, optionally including one or both of the first and second examples, the system further comprises: a fines removal conveyor positioned at least partially inside the enclosure in an operational state and external to the enclosure in a decoupled state. In a fourth example of the system, optionally including one or more or each of the first through third examples, the fines removal conveyor further comprises a sensor configured to determine if the fines removal conveyor is in the operational state or the decoupled state. In a fifth example of the system, optionally including one or more or each of the first through fourth examples, the system further comprises: a controller including instructions stored on non-volatile memory, that when executed cause the controller to: determine if the fines removal conveyor is in the decoupled state, if the fines removal conveyor is in the decoupled state activate the actuator to transition from the enclosure from the closed state to the open state, and maintain the actuator in a deactivated state if the fines removal conveyor is not in the decoupled state.

The disclosure also provides support for a drum filter system of a fryer system, comprising, a tank including an oil inlet and an oil discharge, a hood reversibly coupled to the tank, a rotational arm coupled to the hood, a motor coupled to the rotational arm that when activated rotates the rotational arm, wherein the rotational arm cantilevers the hood away from the tank when rotated. In a first example of the system, the system further comprises: a fines drum positioned internal to the tank and hood, and wherein the fines drum is physically coupled to the hood. In a second example of the system, optionally including the first example, a drum drive motor is coupled to the fines drum and wherein the drum drive motor rotate the fines drum and is physically coupled to the hood. In a third example of the system, optionally including one or both of the first and second examples, wherein the fines drum includes a shaft extending from a closed face of the fines drum and through bearings of brackets, the brackets physically coupled to second brackets, the second brackets physically coupled to the hood. In a fourth example of the system, optionally including one or more or each of the first through third examples, the system further comprises: a fines removal conveyor, wherein the fines removal conveyor includes rails supported by wheels. In a fifth example of the system, optionally including one or more or each of the first through fourth examples, the fines removal conveyor moves laterally along the wheels. In a sixth example of the system, optionally including one or more or each of the first through fifth examples, the fines removal conveyor includes a locking mechanism configured to prevent lateral movement of the fines removal conveyor when engaged. In a seventh example of the system, optionally including one or more or each of the first through sixth examples, in the hood is coupled to the rotational arm by brackets extending from the hood to the rotational arm.

The disclosure also provides support for a method for a drum filter system of a fryer system, comprising: activating a hood actuator of an accessible drum filter system to move a hood of an enclosure of the accessible drum filter system vertically upward and concertedly move a fines drum physically coupled to the hood, wherein moving the hood transitions the enclosure to an open state, and activating the hood actuator to move the hood vertically downward to transition the enclosure to a closed state. In a first example of the method, the method further comprises: moving a fines removal conveyor of the accessible drum filter system to a decoupled state, wherein the fines removal conveyor is positioned outside of the hood in the decoupled state, and in response to a signal from a sensor of the fines removal conveyor indicating the fines removal conveyor in the decoupled state, activating the hood actuator. In a second example of the method, optionally including the first example, the moving the fines removal conveyor includes laterally moving the fines removal conveyor. In a third example of the method, optionally including one or both of the first and second examples, the hood actuator is a motor coupled to a rotational arm of the hood. In a fourth example of the method, optionally including one or more or each of the first through third examples, the hood in the open state is cantilevered above a tank of the accessible drum filter system. In a fifth example of the method, optionally including one or more or each of the first through fourth examples, the enclosure in the open state exposes an interior surface of the fines drum and a tank of the accessible drum filter system for cleaning.

As used herein, the term “approximately” is construed to mean plus or minus five percent of the range unless otherwise specified.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A drum filter system of a fryer system, comprising:
an enclosure including a hood and a tank, wherein a portion of the hood is movably coupled to a portion of the tank, wherein the enclosure is in a closed state when the hood is engaged with the tank and the enclosure is in an open state when the hood is spaced away from the tank;
a fines drum coupled to the hood, and positioned at least partially within the enclosure; and
an actuator coupled to the hood that when activated transitions the enclosure between the closed state and the open state.

2. The drum filter system of claim 1, wherein the fines drum is spaced away from the tank in the open state.

3. The drum filter system of claim 1, wherein the actuator moves the hood vertically upward and away from the tank.

4. The drum filter system of claim 1, further comprising a fines removal conveyor movable between an operational state and a decoupled state, wherein the fines removal conveyor is positioned at least partially inside the enclosure in the operational state and positioned external to the enclosure in the decoupled state.

5. The drum filter system of claim 4, wherein the fines removal conveyor further comprises a sensor configured to determine if the fines removal conveyor is in the operational state or the decoupled state.

6. The drum filter system of claim 5, further comprising a controller including instructions stored on non-volatile memory, that when executed cause the controller to:
determine if the fines removal conveyor is in the decoupled state;
if the fines removal conveyor is in the decoupled state activate the actuator to transition the enclosure from the closed state to the open state; and
maintain the actuator in a deactivated state if the fines removal conveyor is not in the decoupled state.

7. A drum filter system of a fryer system, comprising:
a tank including an oil inlet and an oil discharge;
a hood movably coupled to the tank;
a rotational arm coupled to the hood; and
a hood actuator coupled to the rotational arm, wherein when the hood actuator is activated, the rotational arm rotates and the rotational arm cantilevers the hood away from the tank.

8. The drum filter system of claim 7, further comprising a fines drum positioned internal to the tank and hood, and wherein the fines drum is coupled to the hood and moves with the hood when the hood is moved away from the tank.

9. The drum filter system of claim 8, wherein a drum drive motor is coupled to the fines drum and wherein the drum drive motor rotates the fines drum.

10. The drum filter system of claim 8, wherein the fines drum includes a shaft extending from a closed face of the fines drum and through bearings of brackets, the brackets physically coupled to second brackets, the second brackets physically coupled to the hood.

11. The drum filter system of claim 7, further comprising a fines removal conveyor, wherein the fines removal conveyor includes rails supported by wheels.

12. The drum filter system of claim 11, wherein the fines removal conveyor moves laterally along the wheels.

13. The drum filter system of claim 11, wherein the fines removal conveyor includes a locking mechanism configured to prevent lateral movement of the fines removal conveyor when engaged.

14. The drum filter system of claim 7, where in the hood is coupled to the rotational arm by brackets extending from the hood to the rotational arm.

15. A method for a drum filter system of a fryer system, comprising:
activating a hood actuator of an accessible drum filter system to move a hood of an enclosure of the accessible drum filter system away from a tank of the enclosure and concertedly move a fines drum coupled to the hood, wherein moving the hood transitions the enclosure to an open state; and
activating the hood actuator to move the hood toward the tank to transition the enclosure to a closed state.

16. The method of claim 15, further comprising:
moving a fines removal conveyor of the accessible drum filter system to a decoupled state, wherein the fines removal conveyor is positioned outside of the hood in the decoupled state; and
in response to a signal from a sensor of the fines removal conveyor indicating the fines removal conveyor in the decoupled state, activating the hood actuator.

17. The method of claim 15, wherein the hood actuator is a linear actuator coupled to the hood and the tank of the enclosure.

18. The method of claim 15, wherein the hood actuator is a motor coupled to a rotational arm of the hood.

19. The method of claim 15, wherein the hood in the open state is cantilevered above a tank of the accessible drum filter system.

20. The method of claim 15, wherein the enclosure in the open state exposes an interior surface of the fines drum and a tank of the accessible drum filter system for cleaning.
